(19) United States
(12) Patent Application Publication
(10) Pub. No.: US 2017/0349452 A1
(43) Pub. Date: Dec. 7, 2017

(54) APPARATUS AND METHOD FOR CONCENTRATING BRINE

(71) Applicant: AguaRaider, LLC, Uvalde, TX (US)

(72) Inventors: Alfred Chiu, Kingwood, TX (US); Rader W. Gilleland, Uvalde, TX (US)

(21) Appl. No.: 15/172,615

(22) Filed: Jun. 3, 2016

(51) Int. Cl. C02F 1/12; B01D 1/14; B01D 1/00; C02F 1/00; C02F 1/10; B01D 1/20; C02F 103/10

(52) U.S. Cl. CPC C02F 1/12; C02F 1/10; B01D 1/14; B01D 1/20; B01D 1/0094; C02F 1/004; C02F 2001/007; C02F 2103/10; C02F 2301/046

(57) ABSTRACT

An apparatus and process are provided for concentrating oil and gas production brine. The apparatus comprises a brine feed system, a hot air generation system, a concentrated brine collection and recirculation system, and an evaporation tower. The evaporation tower includes a brine inlet coupled to the brine feed system, a hot air inlet coupled to the hot air generation system and positioned below the brine inlet, a steam discharge, a concentrated brine outlet, a plurality of distillation trays, and a concentrated brine reservoir in the lower portion of the tower. The evaporation tower also has a distributor at the brine inlet adapted to distribute brine onto the trays and may have a plurality of spray nozzles disposed above the hot air inlet to distribute a spray of recirculated concentrated brine. Water evaporates from the brine and the entering hot air temperature is modulated by evaporation.

### FIELD OF INVENTION

The present invention is directed to concentrating byproduct brine generated from oil and gas production to provide a concentrated brine in which the content of each dissolved salt does not exceed its maximum saturation point. The concentrated brine is suitable for off-site disposal by way of deep well injection, providing substantial savings in transportation costs when on-site deep well facilities are not available.

### BACKGROUND OF THE INVENTION

Oil and gas production generates a substantial quantity of wastewater that is contaminated with dissolved minerals, commonly known as brine. Typically, the brine is separated at the well site during the production of gas and oil. Brine contains high concentrations of salts including sodium chloride, calcium chloride, zinc chloride, calcium nitrate, calcium carbonate, magnesium carbonate, sodium bicarbonate, etc., as well as other contaminants. Usually the interstices of oil or gas producing formations contain brine in addition to the oil and/or gas. As a result, a well operator must dispose of significant quantities of brine in an environmentally acceptable manner.

Brine solutions generally exhibit a density of from 8.5 lbs/gallon to 19.2 lbs/gallon. Although brine content varies depending upon the source, the dissolved solids composition of a typical brine is presented in the table below.

Typical analysis of salt recovered from brine

| | | |
|---|---|---|
| CaCl₂ | 20 | wt % |
| NaCl | 75 | wt % |
| MgCl₂ | 2 | wt % |
| CaSO₄ | 1 | wt % |
| BaSO₄ | 66 | ppm |
| LiCl | 240 | ppm |
| Fe | 2 | ppm |
| Heavy Metals | <5 | ppm |

The conventional disposal method for disposing of brine involves the use of injection wells, wherein brine is injected under high pressure into suitable formations. Utilizing injection wells for disposal of oil well brine is expensive. Not only are the wells per se expensive, but many, if not most, sites do not have a deep well facility. One reason for the high expense is thus that the brine must be transported from the site where it is produced to the site of the injection well. This process typically requires an extensive collection network on the order of hundreds of trucks each day. The cost for transporting brine to a suitable injection well is expected to increase as the associated expenses (i.e., fuel, labor, and truck maintenance) continue to rise.

The prior and related art discloses various processes and apparatuses that function, but are not ideal, for handling brine. Brine is often subjected to treatment including one or more of settling tanks, cartridge filters, screen filters, and parallel plate coalescers to remove oil and suspended solids prior to injection. Information regarding brine constituents and typical treatment methods may be found in the Development Document for Final Effluent Limitations Guidelines and Standards for the Coastal Subcategory of the Oil and Gas Extraction Point Source Category, October 1996, published as EPA0821-R-96-023 by the United States Environmental Protection Agency Office of Water, particularly in Chapters VI-VIII.

U.S. Pat. No. 4,804,477 to Allen et al. discloses an apparatus and method for processing oil well brine so that brine transportation is not required, wherein salts precipitate from the brine. The Allen et al. apparatus maintains a brine level that covers the heater tubes and collects a thick slurry of precipitated salt and concentrated brine. Concentrated brine is returned to the main chamber to extract additional salt.

U.S. Pat. No. 4,882,009 to Santoleri et al. provides an apparatus for concentrating brine waters or dewatering brines generated in well drilling operations to a concentration of approximately 20:1. The Santoleri et al. apparatus heats dilute brine using a heat exchanger carrying hot water at a temperature of above 200° F. and receives exhaust gases near temperatures of 1000° F. to further concentrate recycled concentrated brine.

U.S. Pat. No. 5,695,643 to Brandt et al. teaches a process for brine disposal involving concentrating brine in a combustion heat evaporator (submerged combustion evaporator or waste heat evaporator) and either drying the concentrated brine to obtain salt particles or injecting the concentrated brine into a subterranean formation, generally after diluting the brine concentrate to prevent salt precipitation. In most cases, Brandt et al. treats brine with reverse osmosis to obtain a concentrated brine which is further concentrated in the combustion heat evaporator. Brandt et al. also typically requires pretreatment of the brine feed to remove any components that may foul the reverse osmosis membrane, to include calcium carbonate, sulfates, ferric iron, and colloids. In one embodiment, brine is mixed with hot gases from an internal combustion engine in a venturi prior to entering the evaporator. The Brandt et al. combustion heat evaporator operates in the range of about 170-190° F., using exhaust gases having a temperature of about 797° F. above the temperature of the brine. The Brandt et al. evaporator may concentrate, for example, 1250 barrels of partially concentrated brine, which upon dilution results in approximately 500 barrels a day of brine concentrate for injection. Brandt et al. employs a recirculation pump to keep solid particles suspended in the concentrated brine. The salt concentration of the concentrated brine from the Brandt et al. evaporator is typically higher than the maximum solubility of the salt, resulting in a salt slurry, for example from 200,000 ppm to 400,000 ppm or higher.

U.S. Pat. No. 7,513,972 to Hart et al. discloses a portable brine evaporator unit, process and system to save money by avoiding increases in transportation costs. Brine is sprayed onto a heated evaporator drum having a surface temperature of 450-550° F., evaporating water and leaving solid salt which must be scraped from the surface of the drum. The Hart et al. evaporator unit can process about 1-3 gallons/minute brine at 25 psi±5 psi, or 3,000 gallons of brine in approximately two days. The Hart et al. device is intended to obviate the need for transportation and injection of brine and is not designed or operated to treat brine prior to transportation and injection.

Although the prior art references discussed above show that it is possible to concentrate brine, there remains a need for a more efficient method to process the brine at the production site.

### SUMMARY OF THE INVENTION

The present invention provides for a reduction in the quantity of brine through direct evaporation. Thereby a much smaller volume of concentrated brine residue remains to be trucked to an injection well.

The invention is drawn to an apparatus for concentrating oil and gas production brine. The apparatus comprises (a) a brine feed system, (b) a hot air generation system, (c) a concentrated brine collection and recirculation system, and (d) an evaporation tower. The evaporation tower includes (i) a brine inlet coupled to the brine feed system, (ii) a hot air inlet coupled to the hot air generation system and positioned lower than the brine inlet, (iii) a steam discharge, (iv) a concentrated brine outlet, (v) a first evaporation zone, and (vi) a second evaporation zone. The first evaporation zone comprises a plurality of spray nozzles positioned across the horizontal cross section of the tower above the hot air inlet, adapted to distribute a spray of recirculated concentrated brine. Water evaporates from the recirculated concentrated brine and modulates the temperature of entering hot air. The second evaporation zone comprises evaporation media with open flow channels and a distributor at the brine inlet adapted to distribute brine onto the evaporation media. The apparatus is adapted to remove a portion of water from the brine feed to produce a concentrated brine.

The advantages of the present invention include the following features. The inventive process protects equipment from heat degradation and fouling. The inventive process is more reliable than conventional processes in allowing the concentration to more closely approach full saturation without exceeding the saturation point. The inventive apparatus is simple to operate and is, for the most part, self-regulating. The apparatus is also compact due to the highly efficient evaporation achieved by the two-zone process.

Other aspects and advantages of the present invention are described in the detailed description below and in the claims.

### BRIEF DESCRIPTION OF THE DRAWINGS

The invention is described in detail below with reference to the appended drawings, wherein like numerals designate similar parts. In the Figures:

FIG. 1 is a schematic diagram illustrating the novel evaporator unit and process of reducing the quantity of brine;

FIG. 2 is a partial top perspective view of a dual flow tray which is disposed in the vessel 40 in one embodiment of the present invention; and

FIG. 3 is a partial top perspective view of a dual flow tray which is disposed in the vessel 40 in one embodiment of the present invention.

### DETAILED DESCRIPTION OF THE INVENTION

The invention is described in detail below with reference to several embodiments and numerous examples. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below.

With respect to the various ranges set forth herein, any upper limit recited may, of course, be combined with any lower limit for selected sub-ranges.

The transitional phrase “consisting essentially of” limits the scope of a claim to the specified materials or steps “and those that do not materially affect the basic and novel characteristic(s)” of the claimed invention. As used herein with respect to process claims, “consisting essentially of” means that the steps are carried out in the recited sequence and exclude steps therebetween that involve substantial treatment of the partially concentrated brine or final brine concentrate; for example, intermediate steps would not involve treatment of more than about 5% of the partially concentrated brine. With respect to apparatus claims, “consisting essentially of” and like terminology refers to the recited components and excludes other components which would substantially change the basic and novel characteristics of the apparatus.

Hydraulic diameter, D_{H}, is a term used in calculation regarding turbulent flow in non-circular tubes and channels, particularly with respect to heat transfer. Hydraulic diameter is calculated as 4 times the cross-sectional area, A, divided by the wetted perimeter of the cross section, P. The hydraulic radius is ¼ of the hydraulic diameter.

“Pitch” refers to the distance between the center of one hole to the center of an adjacent hole in a perforated tray.

“Open area” refers to the gross area of openings in a perforated tray. For a tray pattern having a triangular pitch, open area is calculated as the square of the hole diameter, multiplied by 90.69, divided by the square of the pitch.

“Dual flow tray” or “bubble tray” refers to a perforated tray that effects countercurrent contact of a liquid with a gas or vapor. The perforations (i.e., openings or holes) may be square, triangular, rectangular, oblong, round, or any convenient shape and are generally arranged uniformly with respect to each other over the developed area. Preferably, the perforations are round in shape.

“Ripple tray” refers to an alternative embodiment of a dual flow tray, in which the perforated tray is corrugated in a substantially sinusoidal or “V”-shaped pattern. A fractionation tray of the ripple tray class is disclosed in U.S. Pat. No. 2,767,967 to M. H. Hutchinson, the disclosure of which is incorporated by reference. A ripple tray is a perforated tray characterized by the presence of a plurality of uniformly or substantially uniformly spaced high and low areas. The three-dimensional surface of a ripple tray possesses an open area greater per unit of projected area than it presented in flat form prior to formation by means such as pressing.

The specific evaporation rate (SER) refers to the water evaporation rate normalized to the size of the evaporation tower. For example, the pounds of water evaporated per hour for each square foot of tray surface area (lbs/ft²·hr) provides an evaporation rate normalized to the surface area available on the trays present in the evaporation vessel. Alternatively, a SER may rely on the pounds of water evaporated per hour for each pound of hot gas introduced to the evaporator (lbs/lbs·hr).

The present invention provides for an apparatus and associated process for reducing the quantity of oil and gas production brine wastewater. The inventive process may treat about 130 barrels per day, or less, up to about 13,000 barrels per day utilizing a suitably sized apparatus. In one embodiment, up to about 1,300 barrels per day of brine may be treated, based upon an ambient temperature of about 40° F. and an initial total dissolved solids (TDS) concentration of about 20,000 weight ppm. Preferably, the process and apparatus are suitable to treat brine at a rate of at least about 1,200 barrels per day.

The invention provides several advantages. The inventive process and apparatus allow efficient, continuous operation without plugging. The apparatus resists damage due to excessive heat and corrosion. The invention provides a highly efficient evaporation rate for the amount of fuel consumed. The apparatus is characterized by compact size for the amount of brine processed.

The process increases the total dissolved solids concentration present in the brine by as much as about 10 times, for example from about 20,000 ppm weight to about 200,000 ppm weight, or to the maximum saturation point of the total dissolved solids. The maximum saturation point refers to the point at which no more solute can be dissolved in the solution and varies depending upon the brine feed composition. Preferably, the brine is not concentrated beyond the saturation point of the TDS as doing so will result in the precipitation of minerals which cause plugging of the system over time. Even more preferably, the brine is concentrated to whichever of the former thresholds occurs first. The maximum saturation point of the TDS will be dependent on many factors of the chemical environment, varying by production site. The inventive evaporation unit surprisingly allows the operator to more closely approach, yet not exceed, the maximum saturation point than do prior art apparatuses.

In some embodiments, the brine is treated prior to evaporation such that the brine fed to the apparatus is essentially free of suspended solids and contains a negligible, or minimal, amount of heat sensitive organic components. Heat sensitive organic components can form polymers and/or degradation products that may cause plugging of the system over time. Some examples of organic components may include oil and grease, benzene, toluene, n-alkanes, phenol, and the like. In some cases, a residual load of dissolved organic components may remain in the brine feed. As a result of the high heat present in the evaporator, at least a portion of any residual dissolved organic load vaporizes and escapes the tower with water vapor.

The inventive apparatus and process are characterized by the following superior and surprising results. The inventive process protects equipment from heat degradation and fouling. The inventive process is more reliable than conventional processes in allowing the concentration to more closely approach full saturation without exceeding the saturation point. The inventive apparatus is simple to operate and is, for the most part, self-regulating. The apparatus is also compact due to the highly efficient evaporation achieved by the two-zone process.

The inventive apparatus is provided with a brine supply, an evaporation vessel, a heat source such as a burner, and a brine concentrate collection and recirculation system. The evaporation vessel provides two evaporation zones.

The first evaporation zone is associated with the hot air inlet. Brine concentrate is recirculated to the hot air inlet and finely distributed. Hot air enters the evaporation vessel at a very high temperature, greater than 1000° F., for example greater than 2000° F., preferably about 1000° F. up to a maximum temperature of 2800° F., and more preferably about 2600 to 2700° F. The very hot air entering the evaporation tower is quenched by contact with the recirculated brine concentrate by transferring heat from the hot air to the brine concentrate. The majority of heat entering at the hot air inlet is transferred to the brine concentrate spray in the first evaporation zone. The quenched hot air rises and thus serves as hot air provided to the second evaporation zone. The brine concentrate spray may be distributed through a plurality of nozzles from 4/100″ to 3″ in diameter, preferably ⅛″ to 2″ in diameter, such as about ¼″ in diameter. The nozzle size is selected to avoid plugging that may occur if the dissolved salts precipitate.

The second evaporation zone is associated with the inlet from the brine supply at which point incoming brine is finely distributed and is intimately contacted with hot air or other gases to transfer heat to the brine and evaporate water therefrom. For example, the brine may be distributed through a plurality of nozzles from 4/100″ to 3″ in diameter, preferably ⅛″ to 2″ in diameter, such as about ¼″ in diameter. The nozzle size is selected to avoid plugging that may occur if the dissolved salts precipitate. The second evaporation zone occupies an upper portion of the evaporation vessel, for example about the upper ⅛ to ¼ of the vessel, such as about the upper 3/16 of the vessel. The inventive evaporation vessel employs evaporation media with open flow channels, particularly generally planar media such as a plurality of distillation or fractionation trays, to facilitate contact between the distributed brine and hot air. Any commercially available tray type may be used. Preferably, the distillation trays are selected from ripple trays and dual flow trays. More preferably, ripple trays are provided. Alternatively, packing with a large interstitial flow area may be used, although at increased material cost and reduced operational reliability as compared to distillation trays. Any commercially available packing may be used.

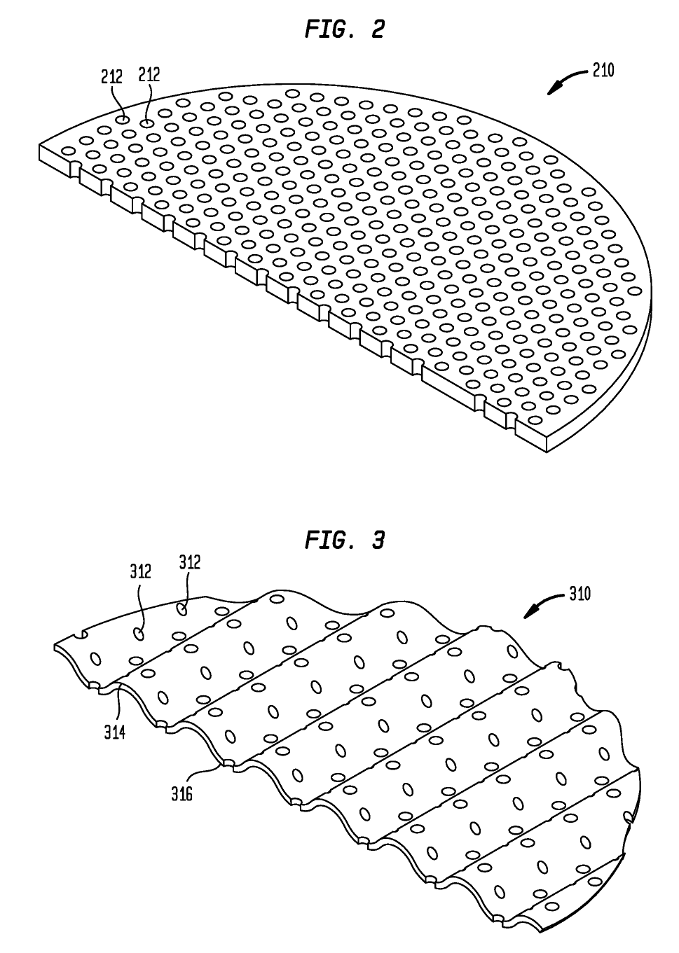

The trays employed in the inventive evaporation vessel have apertures on the order of ¼″ to 3″ in diameter. For example, the aperture diameters may be about 2½″, 2″, or 1″. Preferably, the apertures are about 1 to 3″ inches in diameter, more preferably about 1½ to 2½″ in diameter, most preferably about 2″ in diameter. In some cases, the aperture diameters may be ¼″ to ¾″. In one embodiment, the trays or packing have a hydraulic diameter of at least ¼″. In any case, the diameter must be sufficiently large to avoid plugging and sufficiently small to induce contact between brine and heated gas. The trays employed in the invention possess at least 15% open area. Preferably, the open area is about 15% to about 60%, more preferably from about 20% to about 50%, most preferably from about 20% to about 35%. The trays provide a bubbling or pulsing effect which contributes to heat transfer and thus contributes to water evaporation. Between the trays, some of the evaporated steam recondenses, providing an internal recycle to the process. The extent of water evaporation occurring on the trays may be expressed as pounds of water evaporated per hour for each square foot of tray surface area. At least one tray is generally provided, preferably at least two trays, and in some embodiments three trays or more may be desirable. The number of trays selected is determined at least in part upon the degree of heat transfer efficiency desired. FIG. 2 illustrates a dual flow tray suitable for use in the inventive vessel, while FIG. 3 illustrates a suitable ripple tray for use in the invention.

Brine concentrate produced by evaporating water from incoming brine at the first and second evaporation zones falls to a reservoir located at the bottom of the evaporation vessel and is collected therefrom. For example, concentrated brine reservoir may occupy approximately the lower ⅛ to ¼ of the vessel, such as about the lower 3/16 of the evaporation vessel. As noted above, some of the brine concentrate is recirculated to the first evaporation zone in the evaporation vessel. The recirculated concentrated brine flow rate varies depending upon factors such as the vessel size, the temperature of the very hot air, and amount of water remaining in the brine concentrate, but in some embodiments, a suitable flow rate may range between about 20 gpm and 200 gpm. Additional brine concentrate may be recirculated to the brine inlet and combined with incoming brine feed that has not undergone concentration. The remaining brine concentrate is either held in an appropriate vessel or is collected for transport to a suitable injection well.

Concentrated brine collected from the reservoir for internal circulation is periodically sampled to determine the presence of any precipitation. Sampling may occur as infrequently as once a week or more frequently, for example, once or twice per day, as determined necessary based upon variation in brine composition and feed rate. As the incoming brine feed has a high concentration of dissolved solids even prior to evaporation, the concentrated brine must be monitored for very high levels of salt and carbonate precipitate that may result.

Evaporated water vapor, or steam, rises through an outlet at the top of the evaporation vessel.

The inventive evaporation vessel may be sized as appropriate to the amount of brine to be treated, to the local conditions and to available space, etc. Thus, the tower outer diameter may range from about 1 foot to about 100 feet, while the tower height may range from about 1⅔ feet to about 160 feet, as appropriate to the parameters discussed above. For example, an evaporation tower according to the invention may have about a 10 foot outer diameter and a height of about 16 feet. Thus, an exemplary evaporation unit volume may be, for example, about 1300 ft³. However, the portion of the tower in which heat transfer occurs is approximately ⅓ of the total height, for example about 6 feet of the height of the exemplary unit described above. The horizontal cross-section, in ft², of the tower is directly related to the amount of air blown through, in ft³, and the amount of water evaporated. Therefore, the rate of operation may be measured in ft³ of air flow per ft² of cross-sectional area. The tower height depends upon the number of trays or the amount of packing required. Any suitable material may be used for the evaporation vessel, such as carbon steel, coated with a suitable material to avoid corrosion, such as an epoxy polymer. The tower wall is also preferably insulated, for example with a suitable coating material.

The evaporation rate is primarily dependent upon the flow rates of flue gas and air flow. The air flow necessary depends upon the temperature of the air entering the tower and the water content of the brine. For example, the air flow provided to the tower may be within a range of from about 0.75 to about 2 pounds of air per pound of water evaporated. The flow rate may be controlled by any suitable means known in the art, such as variable frequency drives (VFD) or by control valves.

The very high temperature gas provided to the evaporation unit is preferably predominantly air enriched with carbon dioxide from combustion and has a temperature preferably greater than about 1500° F. The gas is quenched with recirculated brine such that the resulting gas temperature is not greater than about 350° F., measured at the tower wall opposite the hot air inlet immediately below the trays. The recirculated brine flowrate is generally initially set to the maximum and is adjusted as necessary to maintain a quenched-air temperature preferably below about 320° F., more preferably below about 300° F. The flow rate may be controlled by any suitable means known in the art, such as variable frequency drives (VFD) or by control valves. The exhaust gas saturated with steam leaves the tower at about 180 to 190° F., as measured midway up a vent stack. The vent stack temperature indicates the degree of evaporation achieved.

Temperature measurement is only necessary at two locations in order to properly operate the inventive apparatus. The temperature of quenched hot air is monitored below the trays and the temperature of steam-containing exhaust gas is monitored in the vent stack provided at the top of the tower. However, the temperature of concentrated brine recirculated to the first evaporation zone may also be monitored.

If insufficient brine or very concentrated brine is fed to the tower, the temperature necessary to evaporate water from the feed, as well as the liquid level, increases. At very low feed rates, tray operation may be compromised; concentrated brine may be recirculated to maintain sufficient liquid flow through the trays to keep a “bubbling” or “pulsing” function operating on the trays. The target stack temperature may also be adjusted to address extremely low feed rates.

The gas flow rate is significantly higher in the vent stack than in the evaporation tower. The vented gas flow rate may be in the range of about 3 to about 20 times greater than the gas flow rate in the evaporation tower. The gases in the evaporation tower may rise at a flow rate of, for example, about 5 feet per second (fps), whereas in the stack, the gas flow rate increases to about 30 fps in one embodiment. In some instances, the vapor in the vented gases may be condensed and collected, if desired.

Any suitable fuel may be used to heat the air entering the evaporation tower providing that the heat content of the fuel provides adequate energy to the incoming air to evaporate the desired amount of water from incoming brine. While not limiting the invention, the fuel is preferably a byproduct of the oil and gas extraction process and may comprise methane, propane, or a mixture thereof. Preferably, the fuel provides about 1,266 BTU per pound of water evaporated given an ambient air and brine temperature of 40° F. The necessary heat content varies dependent upon the ambient temperature and the brine water content and may be adjusted accordingly.

As used herein, pumps may refer to any suitable pumping apparatus known in the art. For example, a pump used in conjunction with the present invention may provide a design flowrate of about 60-100 gpm, operate under about 5-10 horsepower, and provide a discharge of about 60-100 feet, although these parameters are not intended to be limiting. Similarly, air blowers for use with the present invention may refer to any suitable apparatus for forcing movement of air. Such a device may operate under about 10-50 horsepower, provide about 3,500-5,000 standard cubic feet per minute of airflow, and provide a design pressure of about 20-45 inches of water column.

The inventive evaporator may be operated under mild vacuum or moderately increased pressure over the ambient atmospheric pressure. However, the evaporation vessel is generally operated at about atmospheric pressure.

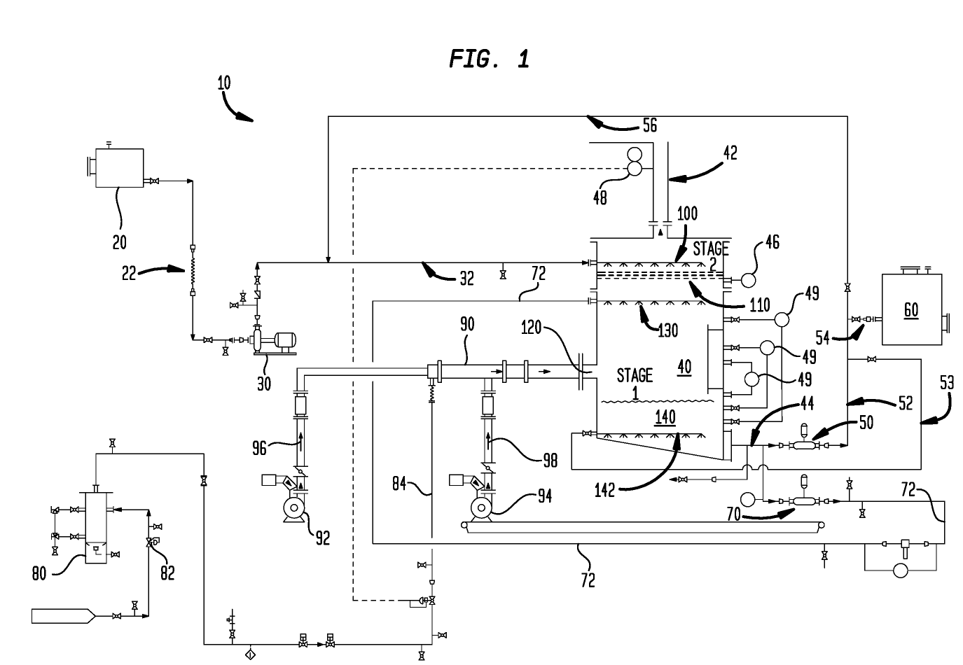

The invention is described by the following example, which is not intended to be limiting. Brine wastewater evaporation system 10 is shown in FIG. 1. The inventive evaporation system comprises a supply tank 20, a feed pump 30, an evaporation tower 40, a brine concentrate pump 50, a concentrate tank or transport 60, a spray pump 70, a fuel gas scrubber 80, and a burner chamber 90. The evaporation tower 40 comprises a brine distributor 100 equipped with a plurality of spray nozzles, two dual flow or ripple trays (optionally including a third tray, as shown) represented collectively as 110, a hot air inlet 120, and a manifold comprising a plurality of spray nozzles 130. A lower portion of evaporation tower 40 further is configured to house a concentrated brine reservoir 140.

The brine feed 22 is drawn from supply tank 20 which in turn is drawn from holding ponds (not shown). The holding ponds may serve a single oil or gas production site or the contents may be collected from multiple sites. A typical holding pond generally accommodates a sufficiently large volume of brine such that the composition does not vary dramatically over time. The brine feed 22 passes through a series of holding tanks and a 100 micron filter (not shown) before entering the supply tank 20 and feed pump 30.

The brine water 32 is fed into an Evaporation Tower 40 under flow control (not shown) by varying the speed of the feed pump 30. The brine water enters through a distributor 100 located above the top of the trays 110, discussed further below.

Fuel gas 84 with a heat content of up to about 1,200 BTU per ft³ is supplied at a minimum pressure of about 100 PSIG through a fuel gas regulator 82. A Fuel Gas Scrubber 80 is provided to prevent condensate carry over into the gas train controls.

Hot air is produced by the combustion of fuel gas in the Burner Chamber 90. The combustion system includes a first air source and a second air source as follows. Approximate stoichiometric air 92 is supplied by Combustion Air Blower 92. Additional air 94, up to 100 percent of stoichiometric, is supplied via a manifold in burner chamber 90 by the Excess Air Blower 94. Together, about 1.02 pounds of air per pound of water evaporated is provided.

Both air blowers' 92, 94 capacities are controlled via variable frequency drives (VFD, not shown). Air flow is monitored by suitable means. Under normal operation, a first air blower runs at the rate capacity while a second air blower is adjusted to provide the optimum air flow.

The total air flow, including the combustion by product, at a temperature of approximately 2,600° F., is fed into the lower portion of evaporation tower 40 at the hot air inlet 120 (positioned above the level of brine concentrate collecting in the reservoir 140 at the bottom of the tower).

According to the invention, evaporation is provided in two zones or stages. The first stage 1 of evaporation occurs at the hot air inlet 120 to evaporation tower 40. The concentrated brine 44 at the bottom of evaporation tower 40 is recirculated via line 72 to a manifold of spray nozzles 130 at a rate of about 100 GPM by the Spray Pump 70. In this stage, very high temperature air is fed to the evaporation tower and cooled with a spray of recirculated brine, thereby cooling the incoming gas prior to said gas impinging upon the walls of the evaporation vessel. The very hot gas in turn serves to provide a very high local water evaporation rate.

The second stage of evaporation 2 occurs when the quenched air, produced by contacting hot air at inlet 120 with recirculated concentrated brine 72, along with the produced steam, rises through the trays 110 in evaporation tower 40, where the quenched air contacts the brine incoming via the distributor 100. The quenched air preferably has a temperature less than about 300° F. as measured at temperature sensor 46.

The combined stream, consisting of air and evaporated water vapor, rises through a vent stack 42 to the atmosphere at an outlet temperature of approximately 180° F., measured at temperature sensor 48.

The concentrated brine 44, or brine concentrate, collected in the reservoir 140 at the bottom of evaporation tower 40 is removed by the Brine Concentrate Pump 50 under level control 49. FIG. 1 illustrates an embodiment wherein level control 49 comprises a level glass for visual inspection as well as a pair of electronic transmitters suitable for remotely monitoring brine level. Brine concentrate pump 50 capacity is controlled by VFD. The brine concentrate stream 52 may be sent to a holding pond or to containers for transport via line 54. A portion of the brine concentrate 52 is recirculated to nozzle array 142 in reservoir 140 via line 53 to maintain suspension of any precipitate that may be present.

A side stream 56 from brine concentrate pump 50 may also be recirculated and combined with the brine feed 22 to form a combined brine feed which enters the evaporation tower 40 via line 32 at the distributor 100. Recirculation to the feed line 22 is provided to maintain the liquid level in the tower 40 and reservoir 140.

Flow from the brine concentrate pump 50 to the concentrate tank or transport 60 is adjusted as necessary to attain the desired salt concentration without precipitating salts from the concentrated brine.

Concentrated brine 44 collected from the evaporation vessel for internal circulation through spray pump 70 is periodically sampled to determine the presence of any precipitation. Sampling preferably occurs once per day. Spray nozzles 130 and spray nozzles present within the distributor 100 have a diameter of ¼″.

In the event of cleaning or maintenance, the reservoir 140 may be drained and the concentrated brine 44 may be routed to a truck for appropriate disposal.

FIGS. 2 and 3 show alternative embodiments of the plurality of trays 110 of the present invention in partial top perspective views. FIG. 2 presents a dual-flow tray 210. A plurality of holes 212 are evenly dispersed across the surface of the tray 210. The tray exemplified in FIG. 2 is characterized by an open area of about 22.7% of the developed area of the tray.

FIG. 3 presents a ripple tray 310. A plurality of holes 312 are evenly dispersed across the surface of the tray 310. The ripple tray 310 primarily differs from the dual-flow tray 210 of FIG. 2 in that the ripple tray 310 has multiple alternating elevated areas 314 and depressed areas 316 areas evenly distributed across the tray 310.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. An apparatus for concentrating oil and gas production brine, the apparatus comprising:
(a) a brine feed system, (b) a hot air generation system, (c) a concentrated brine collection and recirculation system, and (d) an evaporation tower including:
(i) a brine inlet coupled to the brine feed system, (ii) a hot air inlet coupled to the hot air generation system and positioned lower than the brine inlet, (iii) a steam discharge, (iv) a concentrated brine outlet, (v) at least one distillation tray positioned below the brine inlet and above the hot air inlet, (vi) a distributor coupled to the brine inlet and adapted to distribute brine onto the at least one distillation tray, and (vii) a lower portion of the tower configured to house a concentrated brine reservoir; and
wherein the apparatus is adapted to remove a portion of water from the oil and gas production brine to produce a concentrated brine.

2. The apparatus of claim 1, wherein the concentrated brine collection and recirculation system further comprises a plurality of spray nozzles disposed above the hot air inlet and below the at least one distillation tray, adapted to distribute a spray of recirculated concentrated brine, thereby evaporating water from the recirculated concentrated brine and modulating the temperature of entering hot air by evaporation.

3. The apparatus of claim 2, wherein the plurality of spray nozzles disposed above the hot air inlet and below the at least one distillation tray have a diameter of about 4/100 to about 3 inches.

4. The apparatus of claim 1, wherein the at least one distillation tray has a plurality of holes distributed therein such that the open area of the tray is from about 15% to about 50% of the tray surface area.

5. The apparatus of claim 4, wherein the plurality of holes have a diameter of about ¼ to about 3 inches.

6. The apparatus of claim 1, comprising one to four dual flow trays which are positioned below the distributor.

7. The apparatus of claim 1, wherein the distributor comprises a plurality of spray nozzles adapted to distribute the brine as a spray onto the at least one distillation tray.

8. The apparatus of claim 7, wherein the plurality of spray nozzles provided in the distributor have a diameter of about 4/100 to about 3 inches.

9. The apparatus of claim 1, wherein further the apparatus comprises a burner chamber positioned to provide hot air to the hot air inlet.

10. The apparatus of claim 9, wherein the burner chamber is provided with a plurality of air intakes.

11. The apparatus of claim 2, wherein the concentrated brine collection and recirculation system is adapted to provide at least a portion of the concentrated brine to the spray nozzles disposed above the hot air inlet and below the at least one distillation tray.

12. The apparatus of claim 1, wherein the concentrated brine collection and recirculation system is adapted to provide at least a portion of the concentrated brine to the brine inlet.

13. An apparatus for concentrating oil and gas production brine, the apparatus comprising:
(a) a brine feed system, (b) a hot air generation system, (c) a concentrated brine collection and recirculation system, and (d) an evaporation tower including:
(i) a brine inlet coupled to the brine feed system, (ii) a hot air inlet coupled to the hot air generation system and positioned lower than the brine inlet, (iii) a steam discharge, (iv) a concentrated brine outlet, (v) a first evaporation zone, and (vi) a second evaporation zone;
wherein the first evaporation zone comprises a plurality of spray nozzles disposed above the hot air inlet, adapted to distribute a spray of recirculated concentrated brine, thereby evaporating water from the recirculated concentrated brine and modulating the temperature of entering hot air by evaporation; and
wherein the second evaporation zone comprises evaporation media with open flow channels and a distributor at the brine inlet adapted to distribute brine onto the evaporation media.

14. The apparatus of claim 13, wherein the hot air inlet is adapted to provide a gaseous stream at an inlet temperature greater than 1000° C. to the evaporation tower.

15. The apparatus of claim 13, wherein the first evaporation zone is positioned in a lower portion of the evaporation tower, such that the first evaporation zone is above the level of concentrated brine collecting at the bottom of the tower and below the second evaporation zone.

16. The apparatus of claim 13, wherein the evaporation media with open flow channels comprises at least one article selected from the group consisting of packing, dual flow trays, and ripple trays.

17. The apparatus of claim 16, wherein the evaporation media are characterized by a hydraulic diameter of at least ¼″.

18. The apparatus of claim 13, wherein the evaporation media with open flow channels comprises a tray with a rippled substrate structure having a plurality of holes distributed therein.

19. A process for concentrating oil and gas production brine, the process comprising:
(a) providing a brine, comprising water and at least one dissolved salt, to a brine inlet of an evaporation tower, (b) providing a heated stream of air to a hot air inlet positioned below the brine inlet, (c) distributing the brine in the form of droplets or a spray upon evaporation media with open flow channels in an inlet evaporation zone, (d) directing the heated stream of air through the evaporation media such that the heated stream of air transfers heat to the brine, producing a concentrated brine, (e) releasing steam and cooled air from the evaporation tower, and (f) collecting and removing concentrated brine in the lower portion of the evaporation tower at a concentrated brine outlet.

20. The process of claim 19, wherein at least a portion of the concentrated brine is recirculated to the evaporation tower as a spray or droplets about the hot air inlet such that water is evaporated from the recirculated brine and the hot air temperature is modulated by the concentrated brine in a recirculation evaporation zone.

21. The process of claim 19, wherein the total dissolved solids concentration of the concentrated brine is greater than the concentration of the brine fed to the brine inlet up to the maximum saturation point of the concentrated brine.

22. The process of claim 19, wherein the brine is pretreated, prior to feeding to the evaporation tower, to remove suspended solids and heat sensitive organic components.

23. The process of claim 22, wherein the pretreatment comprises settling in one or more holding tanks in series.

24. The process of claim 22, wherein the pretreatment comprises filtration.

25. The process of claim 19, wherein the hot air is provided to the evaporation tower at an inlet temperature of from about 1,500 to about 3,000° F.

26. The process of claim 19, wherein the steam and cooled air exit the evaporation tower at an outlet temperature of up to about 200° F.

27. The process of claim 19, wherein the temperature of air rising through the evaporation media is less than about 350° F.

28. The process of claim 19, wherein the concentrated brine is provided to a holding pond or is collected for transport to an injection well.

29. The process of claim 19, wherein a portion of the concentrated brine is recirculated to the brine inlet and fed with brine to the evaporation tower.

30. The process of claim 19, wherein the evaporation media comprises at least one article selected from the group consisting of packing, dual flow trays, and ripple trays.
